(19) United States
(12) Patent Application Publication
(10) Pub. No.: US 2014/0105000 A1
(43) Pub. Date: Apr. 17, 2014

(54) METHOD AND APPARATUS TO DETECT AND COMMUNICATE INFORMATION REGARDING STATE OF COMMUNICATION LINK

(71) Applicant: IKANOS COMMUNICATIONS, INC., Fremont, CA (US)

(72) Inventors: Stephen MUCCIONE, Long Valley, NJ (US); Bhupinder THAKUR, Bangalore (IN); Sushil PRABHU, Ocean, NJ (US); Vipin PATHAK, Eatontown, NJ (US)

(21) Appl. No.: 14/054,006

(22) Filed: Oct. 15, 2013

(30) Foreign Application Priority Data
Oct. 15, 2012 (IN) 4299/CHE/2012

(51) Int. Cl. H04L 12/703

(52) U.S. Cl. CPC H04L 45/28
USPC 370/216

(57) ABSTRACT

The present invention relates to methods and apparatuses for of communicating loss of connectivity to the end-user without the end-user explicitly asking for that information, as well as communicating potential mechanisms to restore the loss of connectivity. In embodiments, after detecting loss of connectivity within the CPE, user requests are redirected to a local web server on the fly, which is running on the CPE. The local webserver returns informational status web pages describing the situation, potential causes, and possible steps to fix the connectivity issue.

### CROSS-REFERENCE TO RELATED APPLICATIONS

This application claims priority to Indian Provisional Patent Application No. 4299/CHE/2012, filed Oct. 15, 2012, the disclosure of which is hereby incorporated by reference in its entirety.

### FIELD OF THE INVENTION

The present invention relates generally to data communications, and more particularly to a method and apparatus for detecting and communicating loss of connectivity to the end-user without the end-user explicitly asking for that information.

### BACKGROUND OF THE INVENTION

Internet Service Providers (ISP)'s are interested in minimizing the number and cost of trouble ticks that may arise from inability of a customer's equipment to communicate with the CO. For example, interface technologies (cable, DSL, etc.) supplying internet connection between a customer's location and the provider's equipment can be interrupted due to physical issues with the wiring connecting the customer premises equipment (CPE) and the ISP's central office (CO). When various impairments occur, the only feedback that is conventionally available to a user using an HTTP based web browser is a message saying that the browser is unable to connect to the remote web server.

### SUMMARY OF THE INVENTION

According to certain general aspects, the present invention relates to methods and apparatuses for of communicating loss of connectivity to the end-user without the end-user explicitly asking for that information, as well as communicating potential mechanisms to restore the loss of connectivity. In embodiments, after detecting loss of connectivity within the CPE, user requests are redirected to a local web server on the fly, which is running on the CPE. The local webserver returns informational status web pages describing the situation, potential causes, and possible steps to fix the connectivity issue.

In accordance with these and other aspects, a method according to embodiments of the invention includes detecting, using a modem chipset in a customer premises equipment (CPE), a loss of connection between the CPE and a wide area access network (WAN), redirecting HTTP traffic from a web browser coupled to the CPE to a local webserver in the CPE while the loss of connection persists, and serving web pages from the CPE to the web browser related to the loss of connection.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an example implementation of embodiments of the invention; and

FIGS. 2 to 4 are screenshots illustrating example pages for display to a user in accordance with aspects of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

General embodiments of the invention include a line monitor module within the CPE, which can automatically initiate diagnostics based on the line condition and collect the results periodically. In an example implementation of embodiments of the invention, when loss of connectivity is detected by the line monitor module, the CPE will trap all Port 80 HTTP communications between the end-user and the CO. It substitutes normal HTTP responses with CPE generated responses. The CPE generated responses can be based upon an analysis of the conditions surrounding the loss of connectivity (e.g. break in wire, wire not connected, presence of a filter on the wire, etc.) and present the user with a web page describing the condition as well as steps to be taken to remediate the condition.

Additionally, the CPE keeps track (either within the CPE, or utilizing storage with the users web browser (via cookie's or by data returned within the replacement web page)) of the original requested web page. When the CPE detects that connectivity has been restored, it terminates the substitution of HTTP responses and directs the user's web browser (either through timeout or direct response by the CPE to a message from the web browser) to retry the HTTP request to the original page. This provides for seamless transition to the original destination without user involvement once connectivity has been restored.

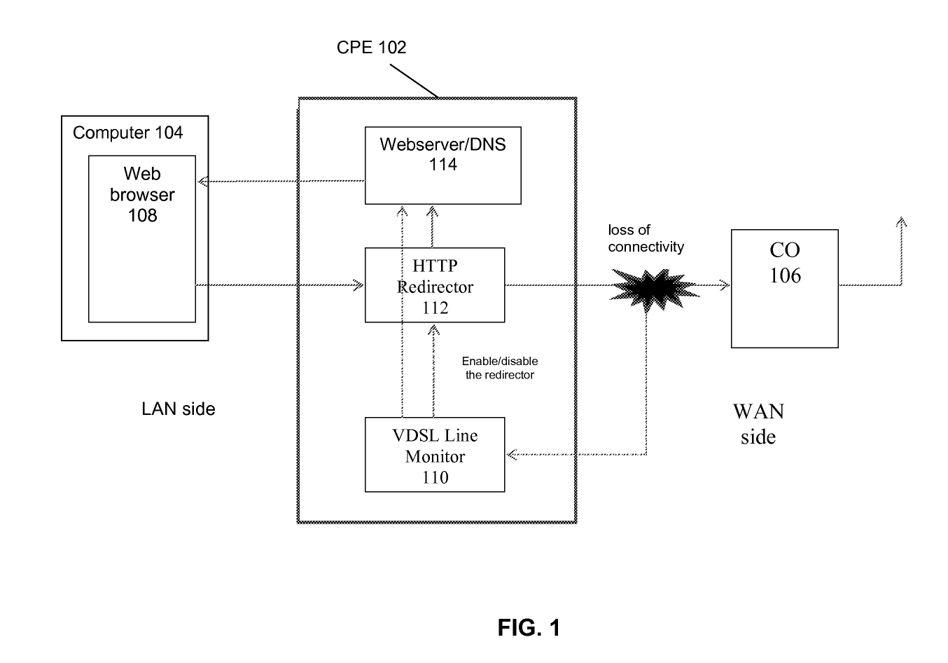

FIG. 1 shows an example system in accordance with embodiments of the invention.

As shown, customer premises equipment (CPE) 102 is interposed between a computer 104 and a central office (CO) 106. According to aspects of the invention, CPE 102 is provided with functionality for determining a loss of connectivity between CPE 102 and the CO 106, and for signaling this event to computer 104, for example via web pages served to a web browser application 108 in computer 104 as will be described in more detail below.

In example embodiments, CPE 102 is a DSL modem with chipsets provided by suppliers such as Ikanos, Inc. of Fremont, Calif. running an operating system such as Linux and supporting protocols such as VDSL 2. Those skilled in the art will be able to understand how to implement the invention in these and other embodiments, for example by adapting firmware or software for such chipsets, after being taught by the descriptions below.

Computer 104 is, for example, a personal computer (PC) such as a desktop, laptop or pad computer coupled to a display (e.g. a flat screen monitor) and executing a conventional operating system such as any of those provided by Microsoft Corp. of Redmond, Wash. or Apple Inc. of Cupertino, Calif. However, the invention is not limited to this example, and computer 104 can be any device having or coupled to a display and having a computer processor that executes a web browser application, such as a set top box, smart TV, DVD player, smart phone, etc.

CPE 102 can be coupled to computer 104 via interface 116. For example, where CPE 102 is a DSL modem, interface 116 can include one or more Ethernet ports to which computer 104 can connect via a cable. Additionally or alternatively, one or more of the Ethernet ports can be connected via cable to a wireless router and computer 104 can communicate with CPE 102 via the wireless router. In embodiments of CPE 102, interface 116 can also include one or more wireless LAN interfaces that are internal to the CPE 102.

CPE 102 can be coupled to CO 106 via any of a number of conventional means. For example, where CPE 102 is a DSL modem, CPE 102 can include a telephone line port into which a conventional telephone line jack can be inserted. The telephone line can be connected ultimately to the CO 106 as is known. Alternatively, where CPE 102 is a cable modem, CPE 102 can include a conventional coaxial cable port into which a conventional coaxial cable jack can be attached, and the coaxial cable can be connected ultimately to the CO as is known.

An example implementation of CPE 102 will now be described in more detail with reference to the illustrated components in the example VDSL modem shown in FIG. 1 and aspects of functionality of the present invention. It should be noted, however, that CPE 102 can include additional components and functionality for supporting conventional DSL modem operations, for example. The details thereof will be omitted here for sake of clarity of the invention. It should be further appreciated that the components shown in FIG. 1 and described in more detail below can be implemented by software or firmware executing on a processor in CPE 102. It should be still further appreciated that the invention can be practiced in other types of CPE's other than VDSL modems.

VDSL Line Monitor 110 monitors the line for any loss of connectivity at a physical level. In embodiments where CPE 102 is a VDSL modem, loss of connectivity is determined when the VDSL modem is not in Showtime communications with CO 106, and re-connection after being down is determined when the VDSL modem returns to Showtime communications with CO 106. When CPE 102 becomes disconnected or connected after being disconnected, it respectively enables or disables HTTP Redirector 112.

In embodiments, after becoming disconnected, VDSL line monitor 110 can further initiate diagnostics to determine the cause of loss of connectivity. For example, the diagnostics can include conventional known modem diagnostics for detecting a break in a wire connected to CPE 102, wire not connected to a jack on CPE 102, etc. Where CPE 102 is a DSL modem, the diagnostics can also include whether a micro filter is inadvertently present on the telephone line to the DSL modem. An example method for determining whether a micro filter is present that can be performed by VDSL line monitor 110 is described in more detail in co-pending Application No. ______ [121K08].

When the line becomes disconnected, VDSL line monitor 110 also sends a command to HTTP redirector 112 to enable itself. If the line comes back up after becoming disconnected, VDSL line monitor 110 sends a command to HTTP redirector 112 to disable itself. In embodiments where VDSL line monitor 110 performs diagnostics, it also feeds webserver 114 with the diagnostics results so that webserver 114 can return that information in a web page to the web browser 108.

HTTP redirector 112 will enable or disable the following configuration based on the corresponding command received from the VDSL Line Monitor 110.
Intercept port 53 traffic (i.e. DNS queries) and re-direct it to the local DNS server 114 running on the CPE 102
Intercept port 80 traffic (i.e. HTTP web browser traffic) and re-direct it to the local web server 114 running on the CPE 102

This configuration is effected through the configuration of iptables rules, which are created or deleted by HTTP redirector 112 based on whether it has been enabled or disabled by the VDSL Line Monitor module. In embodiments, the iptables rules are included in a conventional Linux IP stack, and those skilled in the art will understand how to adapt such rules for effecting the redirection of HTTP and DNS traffic according to embodiments of the invention after being taught by the present disclosure.

In embodiments, local DNS server 114 is always running, but does not perform any substantive actions unless port 53 traffic is being intercepted at the CPE 102. DNS server 114 responds to the DNS queries originating from the web browser 108 with the IP address of CPE 102′s LAN (Local Area Network) interface 116. This is required for two reasons: to ensure that web browser 108 does not timeout waiting for a DNS server response because the outside connectivity is lost; and to make the web browser 108 connect to the CPE 102 transparently using a TCP connection. Web browser 108 should not have to know what the connection termination point is.

DNS server 114 directs the web browser 108 through one of the DNS record options to not cache the DNS response, which contains the CPE's LAN interface IP address. This is required so that web browser 108 does not cache this DNS response and should always send the DNS queries until it is resolved with the actual IP address when the connectivity is finally restored.

The present inventors recognize that it is often the case that there are multiple LAN interfaces 116 in a CPE 102 such as eth0, eth1, wlan0, etc. A DNS query could come on any of those interfaces. This presents a problem because the DNS server 114 cannot know which IP address among the different IP addresses of the different LAN interfaces to be returned since there is no information available at an application level as to the specific interface on which the DNS query arrived. According to certain aspects, one solution according to the invention involves looking at the source IP address of the application (which in this case is the web browser 108) from which the DNS query is received and match it against all the IP addresses of the LAN interfaces such as eth0, eth1, Wlan0, wlan1, etc. The interface with the longest IP address match is determined to be the interface 116 on which the DNS request was received. Note that no two LAN interface IP addresses can have the same length match because each interface belongs to a different subnet when configured as routed interfaces.

The web browser 108 thereafter connects to the local web server 114 transparently because it connects to the IP address which is returned by the DNS server 114, which is that of the CPE's LAN interface 116. When a request from web browser 108 are thereafter received, web server 114 determines whether it is a re-directed request (i.e. the intercepted and re-directed one) or it is really a request to access the local web server configuration pages. Note that the CPE 102 also has its own web interface, which is used for managing/configuring the CPE. Web server 114 should not mistakenly serve the VDSL line diagnostics page on those requests.

To determine whether it is a redirected request or not, the web server 114 inspects the “host” HTTP header in the request. This header contains the original URL requested by the browser 108 and remains unchanged even if the request is re-directed.

For local web page access, the “host” field contains the LAN interface 116 IP address.

For a re-directed request, the “host” field contains the original URL, for example www.google.com. The webserver compares the value of the “host” field with the CPE's LAN interface 116 IP addresses. If it matches any of the local interface 116 IP addresses then it will conclude that it is a local web page request. If, however, it does not match any of the local interface 116 IP addresses, then it will conclude that it is a re-directed request and returns the VDSL line diagnostics page.

The VDSL line diagnostics page is preferably a dynamic page. By dynamic page, it is meant that the information it displays will keep on changing based on the diagnostics results, which are fed by the VDSL line monitor. This web page is preferably a self-refreshing page, which for example refreshes itself every 5 seconds by sending a request to the web server 114. Upon such a request, the web server 114 queries the VDSL line monitor 110 for the current diagnostics results, embed them in the web page and return the web page to the web browser 108. In embodiments, this refresh cycle repeat itself, until the line comes up.

Finally, when the line comes up, in the next refresh of the VDSL line diagnostics page, the web server will return a Redirect web page instead of the VDSL line diagnostics page. The redirect page will contain a HTTP directive to connect to the original URL, which was requested by the web browser initially. And the user would be transparently served the original web page, say www.google.com.

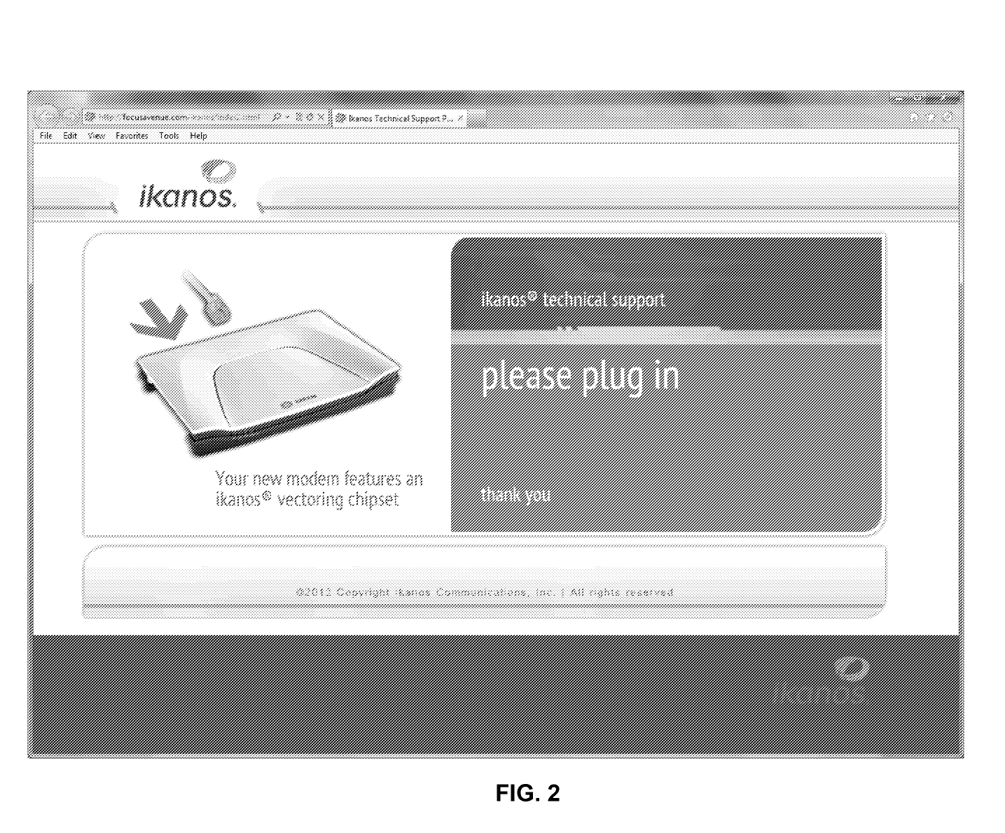

FIGS. 2 to 4 are example web pages that can be generated and displayed in embodiments of the invention.

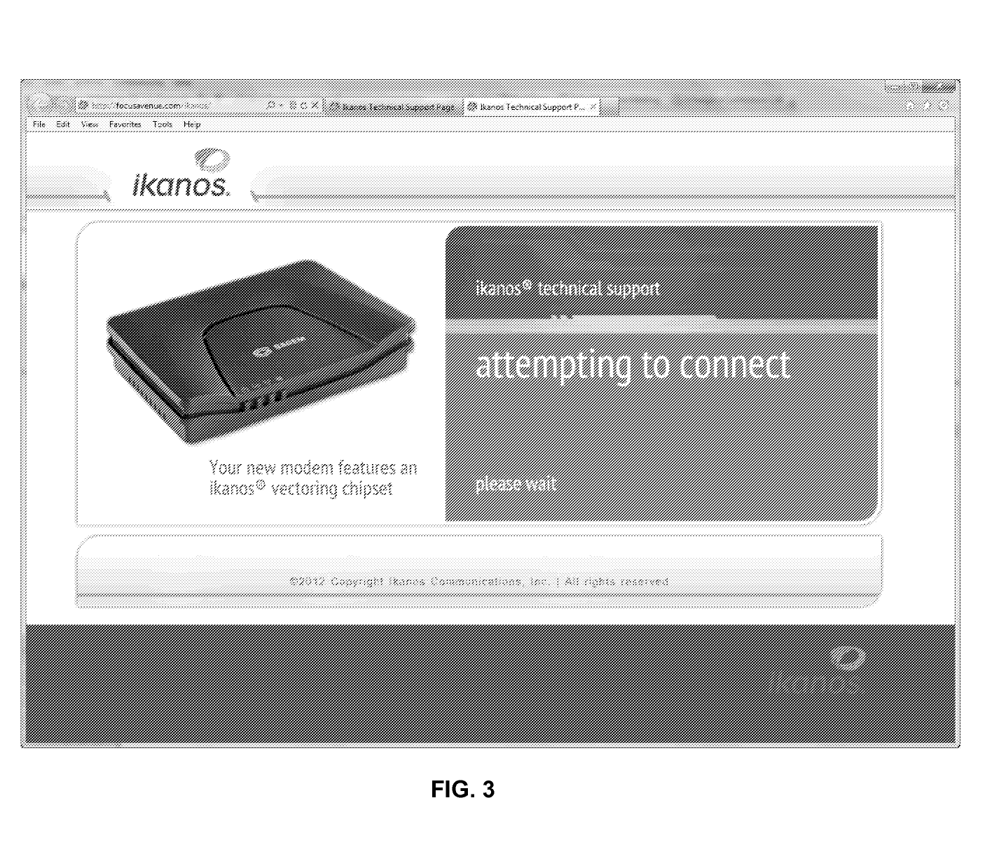

FIG. 2 illustrates an example web page that can be served to web browser 108 when a disconnection has been detected by line monitor 110 and diagnostics have determined that the disconnection is due to an Ethernet cable to computer 104 becoming unplugged from CPE 102. FIG. 3 illustrates an example web page that can be served to web browser 108 after the cable has been plugged back in, but Showtime communications have not yet resumed.

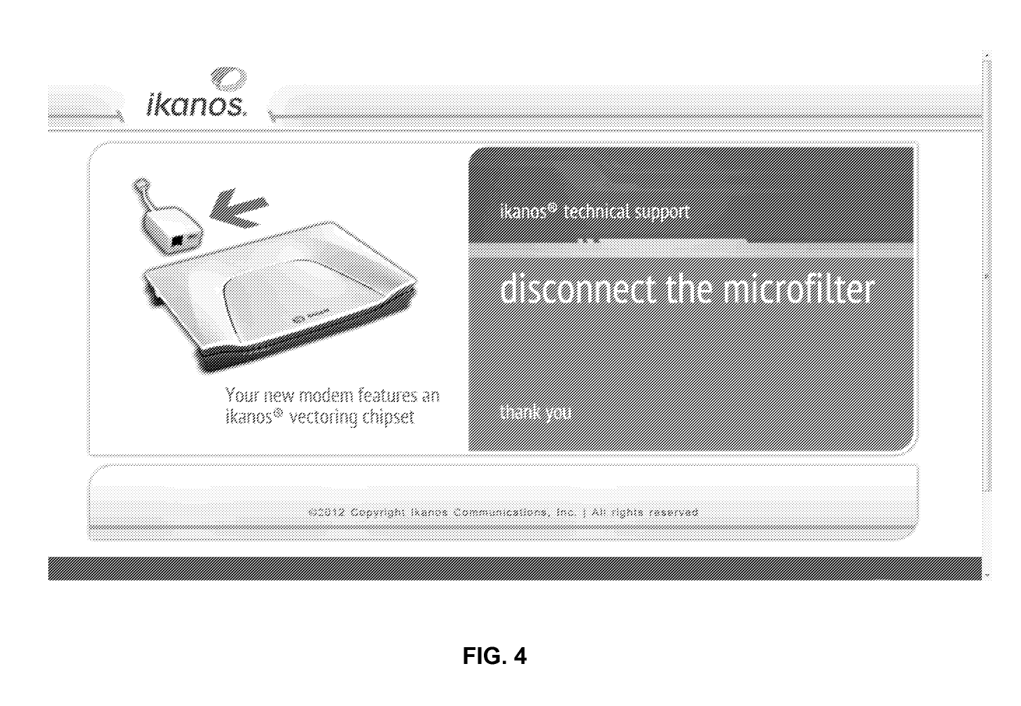

FIG. 4 illustrates an example web page that can be served to web browser 108 when a disconnection has been detected by line monitor 110 and diagnostics have determined that the disconnection is due to the telephone line connection to CPE 102 being plugged into a micro filter.

According to certain aspects, the invention assists the customers to fix the problems on their own, by providing actionable steps, which they can perform by themselves instead of logging a trouble ticket with the operator. It will save customer support costs for the operator. This concept is independent of the specific WAN (Wide Area Network) or LAN (Local Area Network) communication technologies.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

1. A method comprising:
detecting, using a modem chipset in a customer premises equipment (CPE), a loss of connection between the CPE and a wide area access network (WAN);
redirecting HTTP traffic from a web browser coupled to the CPE to a local webserver in the CPE while the loss of connection persists; and
serving web pages from the CPE to the web browser related to the loss of connection.

2. A method according to claim 1, further comprising using a local DNS server to respond to DNS queries with the web browser while the loss of connection persists.

3. A method according to claim 2, wherein the responses include an IP address of the CPE so that the web browser connects to the CPE transparently.

4. A method according to claim 2, further comprising using a host HTTP header in the HTTP traffic from the web browser to determine if the DNS query is a re-directed request.

5. A method according to claim 1, further comprising determining an IP address from a plurality of IP addresses associated with the CPE to be used to cause the web browser to communicate with the CPE.

6. A method according to claim 5, wherein the plurality of IP addresses are associated with LAN interfaces of the CPE.

7. A method according to claim 1, wherein the CPE is a DSL modem.

8. A method according to claim 1, further comprising:
initiating diagnostics to determine a cause of the loss of connection.

9. A method according to claim 8, wherein the diagnostics include determining whether a micro-filter is inadvertently coupled to a WAN interface of the CPE modem.

10. A customer premises equipment (CPE) apparatus comprising:
a line monitor implemented by a modem chipset that detects a loss of connection between the CPE and a wide area access network (WAN);
an HTTP redirector that redirects HTTP traffic from a web browser coupled to the CPE to a local webserver in the CPE while the loss of connection persists,
wherein the web browser is adapted to serve web pages from the CPE to the web browser related to the loss of connection.

11. A CPE apparatus according to claim 10, further comprising a local DNS server that is adapted to respond to DNS queries with the web browser while the loss of connection persists.

12. A CPE apparatus according to claim 11, wherein the responses include an IP address of the CPE so that the web browser connects to the CPE transparently.

13. A CPE apparatus according to claim 11, wherein the HTTP redirector uses a host HTTP header in the HTTP traffic from the web browser to determine if the DNS query is a re-directed request.

14. A CPE apparatus according to claim 10, wherein the HTTP redirector determines an IP address from a plurality of IP addresses associated with the CPE to be used to cause the web browser to communicate with the CPE.

15. A CPE apparatus according to claim 14, wherein the plurality of IP addresses are associated with LAN interfaces of the CPE.

16. A CPE apparatus according to claim 10, wherein the CPE is a DSL modem.

17. A CPE apparatus according to claim 10, wherein the line monitor is further adapted to perform diagnostics to determine a cause of the loss of connection.

18. A CPE apparatus according to claim 17, wherein the diagnostics include determining whether a micro-filter is inadvertently coupled to a WAN interface of the CPE modem.
